(19) United States
(12) Patent Application Publication
(10) Pub. No.: US 2021/0320453 A1
(43) Pub. Date: Oct. 14, 2021

(54) CONNECTOR

(71) Applicant: Yazaki Corporation, Tokyo (JP)

(72) Inventors: Katsuya NAKANO, Kakegawa-shi (JP); Takashi SONE, Kakegawa-shi (JP); Yoshinori HAGITA, Kakegawa-shi (JP)

(73) Assignee: Yazaki Corporation, Tokyo (JP)

(21) Appl. No.: 17/204,458

(22) Filed: Mar. 17, 2021

(30) Foreign Application Priority Data
Apr. 9, 2020 (JP) 2020-070398

(51) Int. Cl. H01R 13/52

(52) U.S. Cl. CPC H01R 13/5202; H01R 13/5219

(57) ABSTRACT

A connector includes a housing and a seal member. The housing includes a groove portion and a protruding portion. The seal member is attached to the groove portion. The groove portion opens outward in a radial direction of the housing and has a bottom surface, a first side wall and a second side wall. The protruding portion extends from the second side wall toward the first side wall and has an end surface. The end surface has an inclined surface inclined such that an outer end of the inclined surface in the radial direction is closer to the first side wall than an inner end of the inclined surface. A first distance between the outer end and the bottom surface is greater than a second distance between the bottom surface and an outer end of a side surface of the seal member in the radial direction.

### CROSS-REFERENCE TO RELATED APPLICATION

The present application claims priority to Japanese Patent Application No. 2020-070398 filed on Apr. 9, 2020, the entire content of which is incorporated herein by reference.

### TECHNICAL FIELD

The present invention relates to a connector.

### BACKGROUND

A related art connector has a waterproof function. For example, the connector is configured such that a ring-shaped seal member is provided between an outer circumferential surface of the connector that holds a plurality of wire-side terminals and an inner circumferential surface of a fitting opening of a counterpart connector. The ring-shaped seal member prevents water from entering fitting portions of both connectors (for example, see JP2004-172009A).

In the above-described connector, in order to prevent the seal member from moving or rotating in a circumferential direction of the connector (that is, occurrence of rotational movement), a protrusion or the like is provided on a housing to be engaged with the seal member to restrict rotation of the seal member. However, when such a protrusion is provided on the housing, the seal member may be deformed and ride/get on the protrusion or the like due to a frictional force or the like exerted by the inner circumferential surface of the fitting opening of the counterpart connector which pushes the seal member along a fitting direction in which the two connectors are fitted to each other. In this case, the seal member riding on the protrusion or the like may hinder the fitting of the connectors themselves.

### SUMMARY

Illustrative aspects of the present invention provide a connector configured to enable proper connector fitting while preventing a rotational movement of a seal member with respect to a housing.

According to an illustrative aspect of the present invention, a connector includes a housing configured to be fitted to a counterpart member and having a fitting portion and a seal member configured to be attached to the fitting portion of the housing. The housing includes a groove portion and at least one protruding portion. The groove portion is configured such that the seal member is attached to the groove portion. The groove portion extends continuously over a circumferential direction of the housing, opens outward in a radial direction of the housing and has a bottom surface, a first side wall provided in a first direction in which the housing is fitted to the counterpart member and a second side wall provided in a second direction being opposite to the first direction. The at least one protruding portion extends from the second side wall toward the first side wall and has an end surface facing the first side wall. At least a part of the end surface has an inclined surface inclined such that an outer end of the inclined surface in the radial direction is closer to the first side wall than an inner end of the inclined surface in the radial direction. The seal member includes an engaging portion configured to, when the seal member is attached to the groove portion, engage with the at least one protruding portion and a side surface configured to, when the seal member is attached to the groove portion, face the end surface of the protruding portion. The engaging portion and the protruding portion are configured to be engaged with each other and to prevent the seal member from moving in the circumferential direction with respect to the housing. A first distance between the outer end of the inclined surface in the radial direction and the bottom surface is greater than a second distance between the bottom surface and an outer end of the side surface of the seal member in the radial direction.

Other aspects and advantages of the invention will be apparent from the following description, the drawings and the claims.

### BRIEF DESCRIPTION OF DRAWINGS

FIG. 1 is a perspective view showing a connector according to an embodiment;

FIG. 2 is a perspective view showing a state where a seal member is attached to an inner housing;

FIG. 3 is a perspective view showing a state where the inner housing and the seal member are separated from each other;

FIG. 4 is a cross-sectional view taken along a line of A-A in FIG. 2;

FIG. 5 is an enlarged view of a portion B in FIG. 4; and

FIG. 6 is an enlarged view of the portion B in FIG. 4 in a state where a connector and a counterpart connector are fitted to each other.

### DESCRIPTION OF EMBODIMENTS

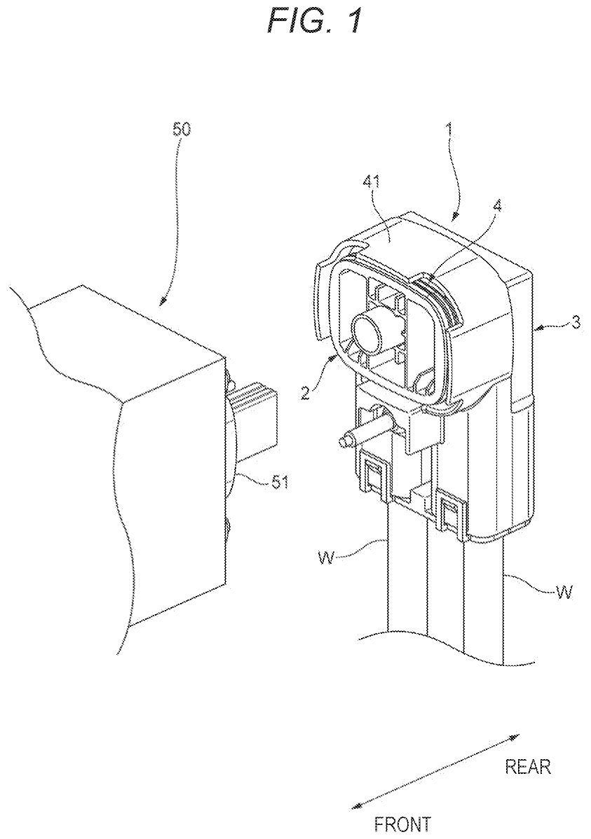

Hereinafter, a connector 1 according to an embodiment shown in FIG. 1 will be described with reference to the drawings. As shown in FIGS. 1 to 3, the connector 1 includes an inner housing 2 (housing), an outer housing 3 to be fitted to the inner housing 2, and a seal member 4 to be attached to the inner housing 2. The connector 1 has a waterproof function. Hereinafter, for convenience of description, “front-rear direction”, “front”, and “rear” are defined as shown in FIGS. 1 to 5. The “front-rear direction” is along a direction in which a connector 1 is fitted to a counterpart connector 50. Also, a “front” side is also referred as a first side and a “rear” side as a second side. A direction oriented from the second side toward the first side is referred to as a first direction and another direction opposite to the first direction is referred to as a second direction. The first and second directions are thus along the front-rear direction.

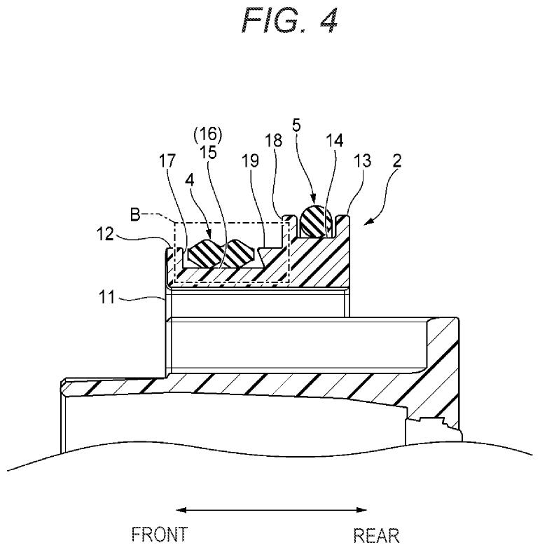

The outer housing 3 formed of resin is fitted to a later-described second fitting portion 13 of the inner housing 2 from a rear side (see FIGS. 1 and 4), i.e., toward the first direction. At this time, a counterpart housing 51 (counterpart member) of a counterpart connector 50 is fitted to a later-described first fitting portion 12 (see FIG. 4) of the inner housing 2 from a front side, i.e., toward the second direction, thereby obtaining a connector unit in which the connector 1 and the counterpart connector 50 are fitted to each other. Further, terminals (female terminals, not shown) accommodated in the connector 1 and terminals (male terminals, not shown) accommodated in the counterpart connector 50 are electrically connected to each other. The terminals accommodated in the connector 1 are electrically connected to electric wires W extending from various electrical components and the like. Hereinafter, each member of the connector 1 will be described in order.

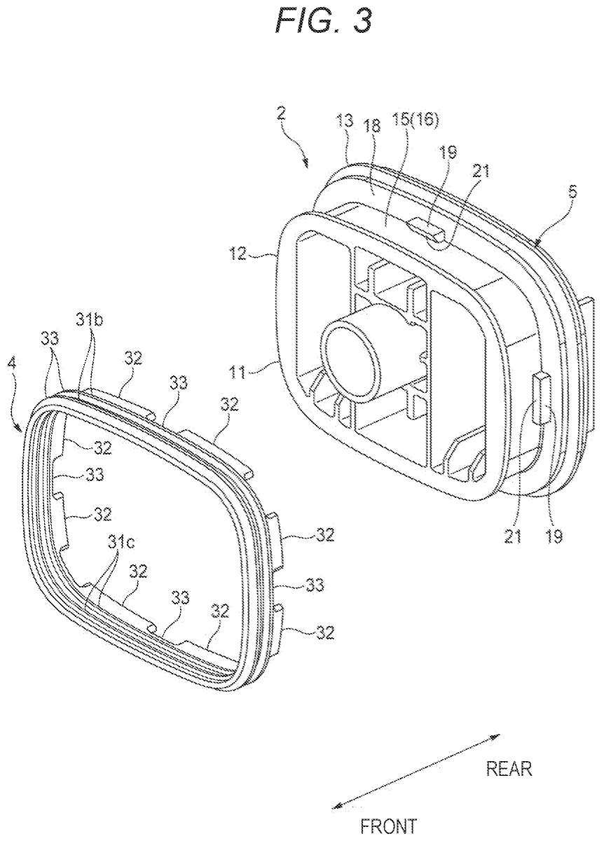

First, the inner housing 2 will be described. As can be understood from FIGS. 3 and 4, the inner housing 2 formed of resin includes a substantially rectangular tubular main body portion 11 extending in the front-rear direction. Hereinafter, for convenience of description, a circumferential direction and a radial direction of the main body portion 11 and of the inner housing 2 are simply referred to as a “circumferential direction” and a “radial direction”, respectively.

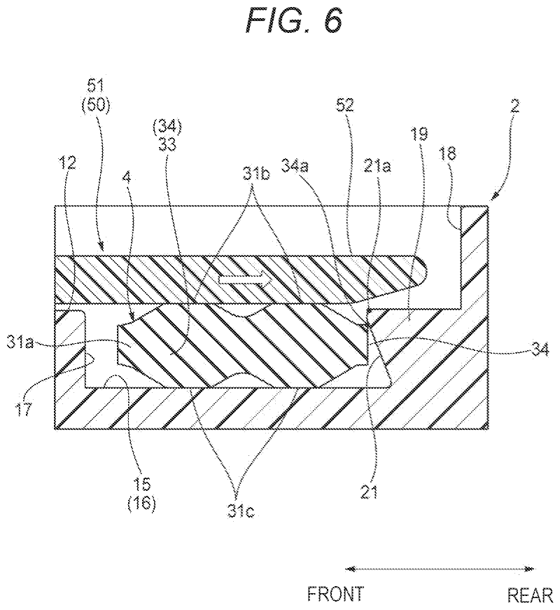

A front side region of an outer circumference portion of the main body portion 11 forms a first fitting portion 12 (fitting portion) to which a substantially rectangular tubular fitting portion 52 (see FIG. 6) of the counterpart housing 51 is externally fitted. A rear side region of the outer circumference portion of the main body portion 11 forms a second fitting portion 13 to which a substantially rectangular tubular fitting portion 41 (see FIG. 1) of the outer housing 3 is externally fitted. The second fitting portion 13 has a larger diameter than that of the first fitting portion 12, and protrudes further outward in the radial direction than the first fitting portion 12 over an entire circumference of the main body portion 11.

As shown in FIG. 4, an annular groove portion 14 is formed on an outer circumferential surface of the second fitting portion 13. A rubber O-ring 5 is to be mounted to the groove portion 14. In a state where the fitting portion 41 of the outer housing 3 is fitted to the second fitting portion 13 from the rear side such that the fitting portion 41 covers the second fitting portion 13 and the inner housing 2 and the outer housing 3 are fitted to each other, an inner circumferential surface of the fitting portion 41 comes into contact with the O-ring 5 in a pressed manner over an entire circumference of the fitting portion 41, whereby a waterproof function of the O-ring 5 is exhibited.

As shown in FIGS. 3 to 5, an groove portion 15 having an annular shape is formed on the outer circumferential surface of the first fitting portion 12. The seal member 4 is to be mounted to the groove portion 15. The groove portion 15 is defined by a bottom surface 16 extending in the circumferential direction and the front-rear direction, a front side surface 17 (first side wall) extending in the circumferential direction and the radial direction, and a rear side surface 18 (second side wall) extending in the circumferential direction and the radial direction. The front side surface 17 and the rear side surface 18 are arranged side by side along the front-rear direction, or a longitudinal direction of the inner housing 2. The front side surface 17 is provided further in the first direction than the rear side surface 18. The front side surface 17 defines an end of the groove portion 15 in the first direction and the rear side surface 18 defines another end of the groove portion 15 in the second direction. The front side surface 17 is to be disposed between the rear side surface 18 and the counterpart connector 50 when the connector 1 is fitted to the counterpart connector 50. The groove portion 15 opens outward in the radial direction.

At a corner portion between the bottom surface 16 and the rear side surface 18 inside the groove portion 15, i.e., at an inner corner portion of the groove portion 15 defined by the bottom surface 16 and the rear side surface 18, protruding portions 19 extending forward, i.e., toward the first direction, from the rear side surface 18 toward the front side surface 17 are formed at a plurality of positions in the circumferential direction. In this example, as can be understood from FIG. 3, the protruding portions 19 are respectively formed at positions corresponding to central portions of four sides of a rectangular shape of the main body portion 11 in the circumferential direction in the groove portion 15 (four positions in total). Each protruding portion 19 extends forward from the rear side surface 18 up to a predetermined position on a rear half region of the groove portion 15 in the front-rear direction. In other words, a distal end of the protruding portion 19 does not reach a central portion of the groove portion 15 in the front-rear direction. The protruding portions 19 are also continuous with/connected to the bottom surface 16.

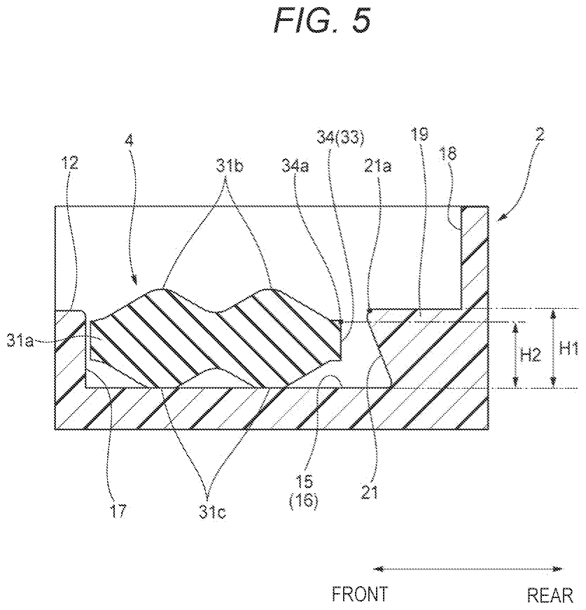

As shown in FIGS. 4 and 5, the protruding portion 19 has a front end surface 21 (end surface) substantially facing the front side surface 17 and being to be facing the seal member 4 when the seal member 4 is attached to the groove portion 15. The front end surface 21 of the protruding portion 19 located on an upper side in FIG. 3 is an inclined surface that is inclined such that the front end surface 21 approaches the front side surface 17 toward an outer side (toward an opening of the groove portion 15) in the radial direction over the entire region. In other words, a part of the front end surface 21 is the inclined surface inclined such that an outer end of the inclined surface 21 in the radial direction is closer to the front side surface 17 than an inner end of the inclined surface in the radial direction. The outer end of the inclined surface 21 in the radial direction is provided further in the first direction than the inner end of the inclined surface 21 in the radial direction. A peripheral edge 21a is provided on the outer end of the inclined surface 21, which can be also described as a distal edge of the protruding portion 19. The front end surfaces 21 of the protruding portions 19 located on a lower side and lateral sides in FIG. 3 may be inclined surfaces similarly inclined, or may be non-inclined surfaces which are perpendicular to the bottom surface 16. For example, when the inner housing 2 is manufactured by an injection molding method, the front end surfaces 21 of the protruding portion 19 on the upper side and the lower side may be inclined surfaces, and the front end surface 21 of the protruding portion 19 on the lateral sides may be non-inclined surface, in consideration of ease of separation from a mold and the like.

Next, the seal member 4 will be described. As shown in FIGS. 3 to 5, the seal member 4 is a rubber packing having a substantially rectangular frame shape and an annular shape, and has a shape corresponding to a shape of the groove portion 15. The seal member 4 includes an annular main body portion 31a, a lip portion 31b and a lip portion 31c. There may be a plurality of lip portions 31b and lip portions 31c. In this embodiment, two lip portions 31b and two lip portions 31c are provided as an example. The lip portions 31b protrude outward in the radial direction from an outer circumferential surface of the main body portion 31a over the entire region of the annular main body portion 31a in the circumferential direction. The lip portions 31c protrude inward in the radial direction from the inner circumferential surface of the main body portion 31a over the entire region in the circumferential direction. The lip portions 31b are formed to be aligned in the front-rear direction. The same applies to the lip portions 31c. An original length of the seal member 4 in the circumferential direction (length when the seal member 4 is not mounted to the inner housing 2) is slightly shorter than a length of the groove portion 15 in the circumferential direction. Therefore, when the seal member 4 is mounted to the groove portion 15, the lip portion 31c on an inner side in the radial direction comes into contact with the bottom surface 16 of the groove portion 15 in a pressed manner due to elastic deformation of the seal member 4.

As shown in FIG. 3, a protruding portion 32 protruding toward the rear side is formed on a rear end surface of the seal member 4 over the entire region in the circumferential direction. In other words, the protruding portion 32 protrudes from the rear end surface of the seal member 4 and extends along the front-rear direction toward the second direction. Recessed portions 33 (engaging portions) are respectively formed at positions corresponding to the protruding portions 19 of the groove portion 15 in the circumferential direction of the protruding portion 32 (four positions in total). The recessed portion 33 is recessed such that a part of the protruding portion 32 is cut out. A side surface 34 defines a front end of the recessed portion 33 in the first direction (see FIG. 5). The side surface 34 can be also described as an inner wall surface 34 of the recessed portion 33. The side surface 34 extends in the circumferential direction and the radial direction. In this example, recessed portions similar to the recessed portions 33 are also formed at positions corresponding to four corners of the rectangular shape of the main body portion 11 in the protruding portion 32.

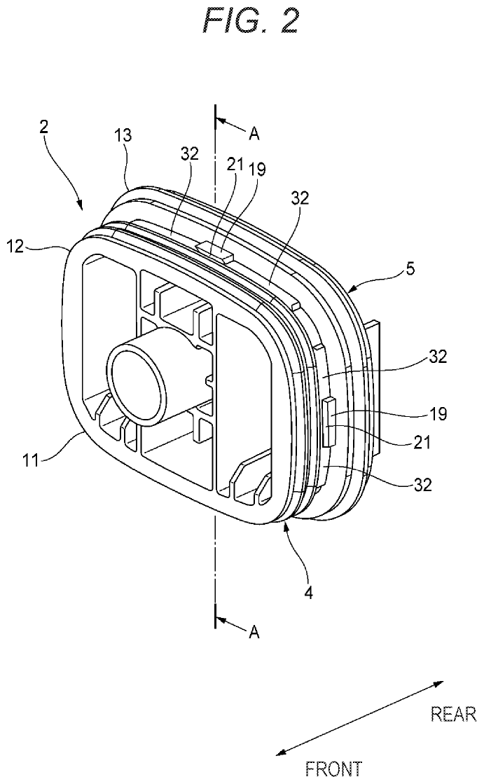

As shown in FIG. 2, the seal member 4 is mounted to the groove portion 15 such that the corresponding protruding portions 19 of the inner housing 2 respectively enter the plurality of recessed portions 33. Accordingly, even when the seal member 4 attempts to be moved relative to the groove portion 15 in the circumferential direction, a side surface of the protruding portion 19 in the circumferential direction and a side surface of the recessed portion 33 in the circumferential direction abut against each other, so that such relative movement is prevented. That is, an interference between the protruding portion 19 and the recessed portion 33 prevents positional deviation of the seal member 4 in the circumferential direction of the inner housing 2.

In a state where the seal member 4 is mounted to the groove portion 15, as shown in FIG. 5, the side surface 34 on a rear side (on a right side in FIG. 5) of the main body portion 31a of the seal member 4 and the front end surface 21 of the protruding portion 19 of the groove portion 15 of the inner housing 2 face each other along the front-rear direction. As described above, the side surface 34 is a part of a recessed surface of the recessed portion 33. The recessed portion 33 has a first peripheral edge 34a and a second peripheral edge extending along the circumferential direction when the seal member 4 is attached to the groove portion 15. The first peripheral edge 34a is to be disposed on an outer side in the radial direction than the second peripheral edge and to be closer to an opening of the groove portion 15 than the second peripheral edge when the seal member is attached to the groove portion. A distance (height) between an outer circumferential surface of the main body portion 31a of the seal member 4 and the bottom surface 16 of the groove portion 15 is defined as “H2 (second/third distance)”. In other words, the distance/height “H2” may be described as a distance between the bottom surface 16 and an outer end 34a of the side surface 34 in the radial direction, or a distance between the bottom surface 16 and the first peripheral edge 34a of the recessed portion 33. A distance (height) between the peripheral edge 21a on the outer end of the front end surface 21 (inclined surface) of the protruding portion 19 of the inner housing 2 in the radial direction and the bottom surface 16 is defined as “H1 (first distance)”. A relationship of “H1>H2” (“H1” is greater than “H2”) is established between H1 and H2. The members of the connector 1 have been described above.

When the connector 1 and the counterpart connector 50 are fitted to each other, the substantially rectangular tubular fitting portion 52 of the counterpart housing 51 is fitted to the first fitting portion 12 (see FIG. 4) of the inner housing 2 from the front side such that the fitting portion 52 covers the first fitting portion 12 as indicated by an arrow in FIG. 6. When the inner housing 2 and the counterpart housing 51 are fitted to each other, the inner circumferential surface of the fitting portion 52 of the counterpart housing 51 comes into contact with the lip portion 31b in a pressed manner on an outer circumferential surface side of the seal member 4 over the entire region in the circumferential direction, and the lip portion 31c on an inner circumferential surface side of the seal member 4 comes into contact with the bottom surface 16 of the groove portion 15 in a pressed manner. As a result, the waterproof function of the seal member 4 is exhibited.

When the substantially rectangular tubular fitting portion 52 of the counterpart housing 51 is externally fitted to the first fitting portion 12 of the inner housing 2 from the front side, a rearward (rightward in FIG. 6) external force may be exerted on the seal member 4 so as to press the seal member 4 toward the front end surface 21 of the protruding portion 19 of the groove portion 15 due to a sliding frictional force or the like between an inner wall surface of the substantially rectangular tubular fitting portion 52 of the counterpart housing 51 and the lip portion 31b of the seal member 4.

Here, the front end surface 21 of the protruding portion 19 has the inclined surface as described above, and the height “H1” is higher than the height “H2” (see FIG. 5). Due to these, when the side surface 34 of the seal member 4 is pressed against the front end surface 21 by the above-described external force, a reaction force exerted on the side surface 34 by the front end surface 21 is directed toward a bottom surface 16 side (inner side in the radial direction) of the groove portion 15. Further, along the inclination of the front end surface 21, the side surface 34 of the seal member 4 is pushed so as to approach the bottom surface 16, or such that the side surface 34 is pressed toward the bottom surface 16 (toward the lower right side of the page of FIG. 5). As a result, even when the external force as described above is applied from the counterpart housing 51 to the seal member 4, the seal member 4 can be prevented from riding on the outer side of the protruding portion 19 in the radial direction.

As described above, according to the connector 1 of the present embodiment, since the protruding portion 19 formed in the groove portion 15 of the inner housing 2 and the recessed portion 33 of the seal member 4 are fitted to each other, it is possible to prevent the positional deviation of the seal member 4 in the circumferential direction of the inner housing 2. Further, the front end surface 21 of the protruding portion 19 has the inclined surface that is inclined such that the outer end of the inclined surface in the radial direction is closer to the front side surface 17 of the groove portion 15 than the inner end of the inclined surface in the radial direction, the inner end being connected to the bottom surface 16. When the counterpart housing 51 is inserted into the inner housing 2, such an external force may be exerted on the seal member 4 so as to press the side surface 34 of the recessed portion 33 of the seal member 4 toward the front end surface 21 of the protruding portion 19. At this time, the front end surface 21 of the protruding portion 19 has the above-described inclined surface, and the height “H1” of the peripheral edge 21a of the front end surface 21 of the protruding portion 19 of the inner housing 2 on the outer side in the radial direction from the bottom surface 16 is higher than the height “H2” of the outer end 34a of the side surface 34 of the recessed portion 33 of the seal member 4 in the radial direction from the bottom surface 16. Therefore, the reaction force exerted on the side surface 34 by the front end surface 21 is directed toward the bottom surface 16 side (inner side in the radial direction) of the groove portion 15. Further, the seal member 4 is pushed so that the side surface 34 gets close to the bottom surface 16. As a result, the seal member 4 is prevented from riding on the protruding portion 19. Therefore, in the connector 1 according to the present embodiment, proper connector fitting can be performed while preventing the positional deviation of the seal member 4 in the circumferential direction with respect to the inner housing 2.

While the present invention has been described with reference to certain exemplary embodiments thereof, the scope of the present invention is not limited to the exemplary embodiments described above, and it will be understood by those skilled in the art that various changes and modifications may be made therein without departing from the scope of the present invention as defined by the appended claims.

In the above embodiment, the protruding portions 19 are formed at a plurality of positions (specifically, four positions) of the groove portion 15 of the inner housing 2 in the circumferential direction. However, the protruding portion 19 may be formed at only one position of the groove portion 15 of the inner housing 2 in the circumferential direction.

Further, in the above-described embodiment, the entirety of the front end surface 21 of the protruding portion 19 has been described as being an inclined surface such that the outer end of the inclined surface in the radial direction is closer to the front side surface 17 than the inner end of the inclined surface in the radial direction (see FIG. 5 and the like). Alternatively, only a part of the front end surface 21 of the protruding portion 19 in the circumferential direction or only a part of the front end surface 21 in the radial direction may be the inclined surface, and a remaining part of the front end surface 21 may be a surface extending in the radial direction perpendicular to the front-rear direction.

Further, in the above embodiment, the two lip portions 31b are provided on the outer peripheral surface side of the seal member 4, and the two lip portions 31c are provided on the inner circumferential surface of the seal member 4. On the other hand, only one lip portion 31b may be provided on the outer circumferential surface side of the seal member 4, or three or more lip portions 31b may be provided on the outer circumferential surface side of the seal member 4. The same applies to the lip portion 31c on the inner circumferential surface side of the seal member 4. Further, the seal member 4 may have only the lip portion 31b on the outer circumferential surface side without having the lip portion 31c on the inner circumferential surface side.

Further, in the above embodiment, the groove portion 15 to which the seal member 4 is mounted includes the bottom surface 16, the front side surface 17, and the rear side surface 18 of the inner housing 2 itself. On the other hand, when a component (for example, a front holder) separately provided from the inner housing 2 is attached to the inner housing 2, the groove portion 15 may be formed by the component and the inner housing 2. As an example, when a separate front holder is attached to the inner housing 2 from a front side, a part of the front holder may be used as the front side surface 17, and the groove portion 15 may include a part thereof, and the bottom surface 16 and the rear side surface 18 of the inner housing 2.

According to an aspect of the embodiments described above, a connector (1) includes a housing (for example, an inner housing 2) configured to be fitted to a counterpart member (for example, a counterpart housing 51) and having a fitting portion (12) and a seal member (4) configured to be attached to the fitting portion (12) of the housing (2). The housing (2) includes a groove portion (15) and at least one protruding portion (19). The groove portion (15) is configured such that the seal member (4) is attached to the groove portion (15). The groove portion (15) extends continuously over a circumferential direction of the housing (2), opens outward in a radial direction of the housing (2) and has a bottom surface, a first side wall (for example, a front side surface 17) provided in a first direction in which the housing (2) is fitted to the counterpart member (51) and a second side wall (for example, rear side surface 18) provided in a second direction being opposite to the first direction. The at least one protruding portion (19) extends from the second side wall (18) toward the first side wall (17) and has an end surface (for example, a front end surface 21) facing the first side wall (17). At least a part of the end surface (21) has an inclined surface (21) inclined such that an outer end (for example, a peripheral edge 21a) of the inclined surface (21) in the radial direction is closer to the first side wall (17) than an inner end of the inclined surface (21) in the radial direction. The seal member (4) includes an engaging portion (33) configured to, when the seal member (4) is attached to the groove portion (15), engage with the at least one protruding portion (19) and a side surface (34) configured to, when the seal member (4) is attached to the groove portion (15), face the end surface (21) of the protruding portion (19). The engaging portion (33) and the protruding portion (19) are configured to be engaged with each other and to prevent the seal member (4) from moving in the circumferential direction with respect to the housing (2). A first distance (H1) between the outer end (21a) of the inclined surface (21) in the radial direction and the bottom surface (16) is greater than a second distance (H2) between the bottom surface (16) and an outer end (34a) of the side surface (34) of the seal member (4) in the radial direction.

According to the connector having the above-described configuration, at least one protruding portion extending from the side surface of the housing on the back side in the fitting direction toward the side surface of the housing on the front side in the fitting direction and the engaging portion of the seal member are fitted to each other, so that it is possible to prevent the positional deviation of the sealing member in the circumferential direction of the housing. Further, at least a part of the end surface of the protruding portion has the inclined surface that is inclined such that the outer end of the inclined surface in the radial direction is closer to the side surface of the housing on the front side than the inner end of the inclined surface in the radial direction. When the counterpart member is inserted into the housing, such an external force may be exerted on the seal member so as to press the seal member toward the end surface of the protruding portion. At this time, the end surface has the above-described inclined surface, and a height of an end portion of the inclined surface on the opening side (hereinafter, referred to as an “inclined surface end portion”) from the bottom surface of the groove portion is higher than a height at which an outer end of the side surface of the seal member in the radial direction is positioned from the bottom surface of the groove portion. Therefore, when the seal member is pressed by the inclined surface, the reaction force exerted on the seal member by the inclined surface is directed to a bottom surface side of the groove portion. As a result, the seal member is prevented from riding on the protruding portion. Therefore, the connector having this configuration enables proper connector fitting while preventing the rotational deviation of the seal member with respect to the housing.

The engaging portion may be a recessed portion (33) having a first peripheral edge (34a) and a second peripheral edge extending along the circumferential direction when the seal member (4) is attached to the groove portion (15). The first peripheral edge (34a) may be disposed on an outer side in the radial direction than the second peripheral edge and may be closer to an opening of the groove portion (15) than the second peripheral edge. When the seal member (4) is attached to the groove portion (15), the first distance (H1) may be greater than a third distance (H2) between the bottom surface (16) and the first peripheral edge (34a).

With this configuration, the peripheral edge of the recessed portion of the seal member, which is considered to have the greatest effect on the riding of the seal member on the protruding portion, is located closer to the bottom surface of the groove portion than the end portion of the inclined surface. Accordingly, it is possible to more appropriately prevent the seal member from riding on the protruding portion. Further, by engaging the engaging portion (recessed portion) of the seal member and the protruding portion of the housing so as to fit each other, it is possible to more appropriately prevent the positional deviation of the seal member in the circumferential direction of the housing

What is claimed is:

1. A connector comprising:
a housing configured to be fitted to a counterpart member and having a fitting portion; and
a seal member configured to be attached to the fitting portion of the housing,
wherein the housing includes a groove portion and at least one protruding portion;
wherein the groove portion is configured such that the seal member is attached to the groove portion, the groove portion extending continuously over a circumferential direction of the housing, opening outward in a radial direction of the housing and having a bottom surface, a first side wall provided in a first direction in which the housing is fitted to the counterpart member and a second side wall provided in a second direction being opposite to the first direction;
wherein the at least one protruding portion extends from the second side wall toward the first side wall and has an end surface facing the first side wall;
wherein at least a part of the end surface has an inclined surface inclined such that an outer end of the inclined surface in the radial direction is closer to the first side wall than an inner end of the inclined surface in the radial direction;
wherein the seal member includes: an engaging portion configured to, when the seal member is attached to the groove portion, engage with the at least one protruding portion; and a side surface configured to, when the seal member is attached to the groove portion, face the end surface of the protruding portion;
wherein the engaging portion and the protruding portion are configured to be engaged with each other and to prevent the seal member from moving in the circumferential direction with respect to the housing; and
wherein a first distance between the outer end of the inclined surface in the radial direction and the bottom surface is greater than a second distance between the bottom surface and an outer end of the side surface of the seal member in the radial direction.

2. The connector according to claim 1,
wherein the engaging portion is a recessed portion having a first peripheral edge and a second peripheral edge extending along the circumferential direction when the seal member is attached to the groove portion, the first peripheral edge being to be disposed on an outer side in the radial direction than the second peripheral edge and being to be closer to an opening of the groove portion than the second peripheral edge; and
wherein, when the seal member is attached to the groove portion, the first distance is greater than a third distance between the bottom surface and the first peripheral edge.
